(19) United States
(12) Patent Application Publication
(10) Pub. No.: US 2017/0012494 A1
(43) Pub. Date: Jan. 12, 2017

(54) Vibration Damper Comprising A Generator Connection

(71) Applicant: ZF FRIEDRICHSHAFEN AG, Friedrichshafen (DE)

(72) Inventors: Robert PRADEL, Röthlein (DE); Helmut BAALMANN, Bergrheinfeld (DE); Andreas FÖRSTER, Schweinfurt (DE); Eberhard SIMON, Gochsheim (DE); Achim THOMAE, Bergrheinfeld (DE); Sebastian SCHNEIDER, Dresden (DE)

(21) Appl. No.: 15/116,460

(22) PCT Filed: Jan. 8, 2015
(86) PCT No.: PCT/EP2015/050202

§ 371 Date: Aug. 3, 2016

(30) Foreign Application Priority Data
Feb. 4, 2014 (DE) 102014201958.3

(51) Int. Cl. H02K 7/18; H02K 11/21; F01D 21/00; H02K 7/06; B60G 13/14; F01D 15/10

(52) U.S. Cl. CPC H02K 7/1823; B60G 13/14; F01D 15/10; F01D 21/003; H02K 7/06; H02K 11/21; F16D 2500/316; B60G 2202/416; B60G 2202/24; B60G 2300/60; F16D 25/00

(57) ABSTRACT

A vibration damper having a cylinder filled with pressurized medium and in which a displacer drives a generator. The vibration damper has a compensation element that compensates pressure peaks from the displacer movement relative to the generator. The compensation element is constructed as a variable-torque clutch.

### CROSS REFERENCE TO RELATED APPLICATIONS

This is a U.S. national stage of application No. PCT/EP2015/050202, filed on Jan. 8, 2015. Priority is claimed on German Application No. DE 1020,14201958.3, filed Feb. 4, 2014, the content of which is incorporated here by reference.

### BACKGROUND OF THE INVENTION

1. Field of the Invention

The invention is directed to a vibration damper with a generator connection.

2. Description of the Prior Art

DE 10 2009 056 874 A1 discloses a vibration damper for a vehicle in which the hydraulic cylinder of the vibration damper is connected to a generator that converts a stroke movement of the vibration damper at least partially into electrical energy. As conventionally used, a vibration damper is subjected to a very wide variety of excitations, which can lead to load peaks at the generator. These load peaks manifest themselves as noise, for example, or also result in damage to the system.

DE 10 2009 056 874 A1 discloses a storage filled with pressurized medium by which the pressure peaks are cushioned. But a storage of this type can lead to added costs in connection with the guiding of lines inside and/or outside of the vibration damper.

### SUMMARY OF THE INVENTION

It is an object of the present invention to find an alternative solution for the problem of pressure peaks occurring within the vibration damper.

According to one aspect of the invention, a compensation element is constructed as a variable-torque clutch. Using the clutch, the transmission of torque from a turbine to an electric machine, as component of the generator, can be flexibly adjusted, particularly with respect to an overloading of the turbine. If the electric machine is decoupled from the turbine in the extreme, the turbine can rev up slightly during a pressure peak and accordingly generate less electric power so that less damping occurs. The entire system is accordingly protected from overloading on the one hand, and noise and impaired comfort are avoided.

According to an advantageous aspect, the clutch is constructed as a controllable magnetic clutch. The magnetic clutch can be adjusted continuously and rapidly.

An overload situation can be detected in a very simple manner in that a turbine of the generator has a speed sensor that provides a speed signal for determining a change of speed.

Alternatively or in combination, the generator can provide an acceleration signal for actuation of the clutch in that, e.g., the change in electric power is detected in a simple manner.

A further possibility consists in that the clutch is constructed as a centrifugal clutch. A centrifugal clutch of this kind reduces the transmission of torque at higher speed.

It can also be provided that the clutch can be actuated by pressurized medium of the vibration damper in the lifting direction.

### BRIEF DESCRIPTION OF THE DRAWINGS

The invention will be described more fully with reference to the following description of the drawings.

FIG. 1 is a schematic view of the vibration damper with a magnetic clutch;

FIG. 2 is a vibration damper with a clutch release; and

FIGS. 3 and 4 are a vibration damper with centrifugal clutch.

### DETAILED DESCRIPTION OF THE PRESENTLY PREFERRED EMBODIMENTS

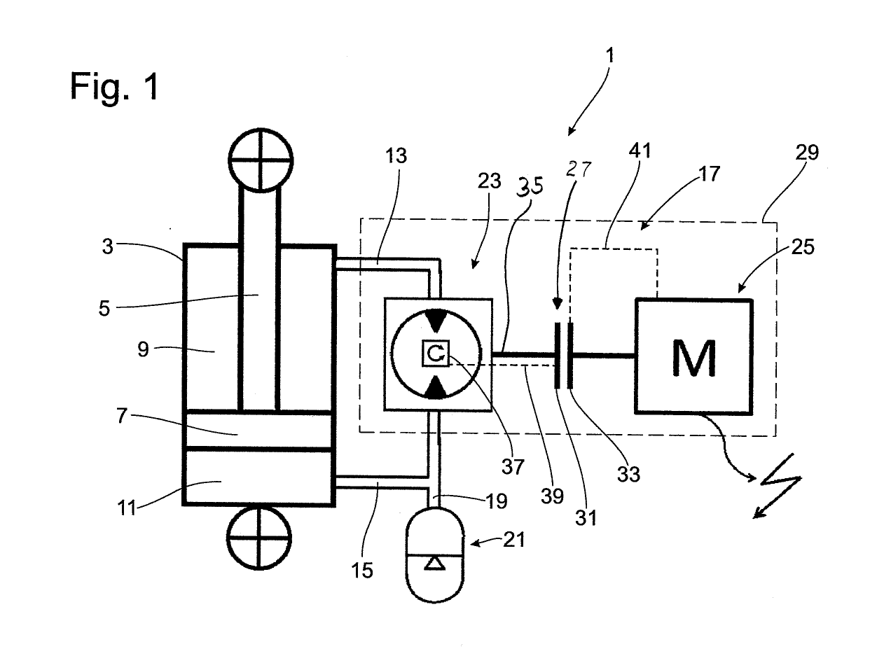

FIG. 1 shows a schematic view of a vibration damper 1 of any constructional type, i.e., monotube vibration damper or twin-tube vibration damper. A piston rod 5, possibly with a piston 7 as displacer, is guided so as to be axially movable in a cylinder 3. Both working chambers 9; 11 of cylinder 3 are completely filled with pressurized medium such that a movement of the displacer conveys pressurized medium through lines 13; 15 to a generator 17, which converts the movement of the displacer into electrical energy.

The vibration damper 1 further comprises, in a bypass line 19 to line 15, a storage 21 that compensates the pressurized medium volume displaced from the cylinder 3 by the piston rod 5. The storage 21 is compressively preloaded such that a pressure volume occurring when the displacer moves into the working chamber 11 is also supplied primarily to the generator 17.

The generator 17 comprises a turbine 23 driven by the displaced pressurized medium. The turbine 23 drives an electric machine 25 that generates the electrical energy. The generator 17 further comprises a clutch 27 as a compensation element that smooths pressure peaks in the pressurized medium or at the turbine 23. Generator 17 can also function as motor when connected to a power source.

The clutch 27 is functionally arranged between turbine 23 and electric machine 25. The clutch can be used as a separate constructional unit or as a component part, e.g., of the turbine. In the present instance, all of the components of the generator 17 are arranged in a common housing 29.

In a first embodiment form, the variable-torque clutch 27 is formed within the shaft 35 between the turbine 23 and the electric machine 25 as a magnetic clutch. An input element 31 is connected on the turbine side and an output element 33 is connected at the motor side. The clutch 27 is closed in normal operation.

Selectively or in combination, the turbine 23 has a speed sensor 37 that provides a speed signal for determining a change of speed, or the electric machine 25 provides an acceleration signal, e.g., by detecting the change in power per unit of time, for actuating the clutch 27. Control lines 39; 41 symbolize the connection of the clutch to the sensor signals. Clutch 27 can be constructed in such a way that it must be actively closed or is passively closed and actively opened. The expression “opened” means that the transmission of torque between the turbine 23 and the electric machine 25 is reduced, and this reduction can possibly be a complete interruption of torque.

In the variant according to FIG. 2, the clutch 27 can be actuated in lifting direction by the pressurized medium of the vibration damper 1. A clutch release 43 in which a preloading spring 45 loads a piston 47 in closing direction of the clutch 27 is used for this purpose. Proceeding from a control line 49, which is connected to the line 15 between the storage 21 and the turbine 23, a lifting force is exerted on the piston 47 of the clutch release 43. During a pressure peak in the hydraulic portion of the vibration damper 1, the pressure level in the control line 49 continues and leads to a lifting movement of the clutch release 43 on the clutch 27 which, as a result, can only transmit a reduced torque so that a relative movement between the input element 31 and output element 33 is possible. Therefore, the mass inertia of the electric machine 25 cannot exert a retaining force opposed to the flow in the turbine 23 so that the turbine 23 is protected against overloading on the one hand, but pressure peaks in the vibration damper 1 can also be avoided.

FIGS. 3 and 4 describe an embodiment form which is completely independent from the supply network 13; 15; 19 of the vibration damper 1 or a sensor signal of the turbine 23 and/or of the electric machine 25. The clutch 27 according to FIGS. 3 and 4 is constructed as a centrifugal clutch, which has a decreasing torque transmission function at decreasing speed. FIG. 4 schematically shows the construction principle. The turbine-side input element 31 has a rotating carrier disk 51 with at least one swivelably supported double-sided lever 53. A flyweight 55 is arranged at a first end of the lever and a friction element 57 is arranged at a second end. A preloading spring 59 loads the lever 53 and, in doing so, presses the friction element 57 against a friction surface 61 of the motor-side output element 33. The preloading spring 59 is supported on a spring disk 63 of the input element 31.

As is shown in FIG. 4, the clutch 27 is closed within a designated speed and/or acceleration range of the clutch. When there is a jump in speed or during a persistently elevated speed, the flyweight 55 with its mass inertia and a lever length 65 up to a joint 67 acts counter to the centrifugal force of the friction element 57 and preloading force of the spring 59 and reduces the friction force between friction element 57 and friction surface 61 of output element 33 so that the transmissible torque of the clutch 27 also changes, i.e., is reduced.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A vibration damper assembly comprising:
a generator;
a cylinder filled with a pressurized medium and having a displacer configured to drive the generator; and
a compensation element configured as a variable-torque clutch that compensates for pressure peaks due to displacer movement relative to the generator.

8. The vibration damper according to claim 7, wherein the variable-torque clutch is configured as a controllable magnetic clutch.

9. The vibration damper according to claim 7, wherein a turbine of the generator has a speed sensor that provides a speed signal for determining a change of speed.

10. The vibration damper according to claim 7, wherein the generator provides an acceleration signal for actuation of the variable-torque clutch.

11. The vibration damper according to claim 7, wherein the variable-torque clutch is configured as a centrifugal clutch.

12. The vibration damper according to claim 7, wherein the variable-torque clutch is actuated in a lifting direction by the pressurized medium of the vibration damper.
